(19) United States
(12) Patent Application Publication
(10) Pub. No.: US 2016/0246488 A1
(43) Pub. Date: Aug. 25, 2016

(54) Media Reveal Feature

(71) Applicants: Jonathan Sassouni, Great Neck, NY (US); David Alan Sassouni, Great Neck, NY (US)

(72) Inventors: Jonathan Sassouni, Great Neck, NY (US); David Alan Sassouni, Great Neck, NY (US)

(21) Appl. No.: 15/051,386

(22) Filed: Feb. 23, 2016

Related U.S. Application Data
(60) Provisional application No. 62/120,283, filed on Feb. 24, 2015.

(51) Int. Cl. G06F 3/0484; G06F 3/0488; H04L 12/58

(52) U.S. Cl. CPC G06F 3/04845; H04L 51/32; H04L 51/10; G06F 3/04842; G06F 3/04883; G06T 2200/24

(57) ABSTRACT

An application for sharing a visual media from an electronic device includes a visual media selection function that selects a visual media for sharing. A spotlight selection function highlights a spotlight area of the visual media and stores the visual media as a sharing media including first media wherein only the spotlight area is visible, and a second media wherein the entire visual media is visible and the spotlight area is highlighted. A first message function stores a first inputted message associated with the first media, and a second message function that stores a second inputted message associated with the second media. A share function transmits the sharing media to at least one second electronic device having the application. A view function displays the sharing media on the second electronic device, by first displaying the first media, and then displaying the second media after receiving a user prompt.

### CROSS REFERENCE TO RELATED APPLICATION

This application claims the benefit of U.S. Provisional Patent Application No. 62/120,283, filed Feb. 24, 2015, which is incorporated herein as if fully set forth.

### FIELD OF THE INVENTION

This disclosure relates to visual media sharing applications for electronic devices.

### BACKGROUND

Photograph and video sharing applications are currently popular, examples of which include Instagram, Snapchat, Facebook, and many others. The common feature among these applications is the ability to share media with other people, often designated as “friends” or “followers” and comment about the media to each other. Each application has additional feature sets that distinguish it from others, and these feature sets often drive traffic to the application.

For example, Snapchat includes a timer that allows sharing a photograph for only a preset time, after which it is deleted forever. Facebook allows for many levels of sharing with others. Instagram has a more robust photograph interface than the others. A feature can be the prime driver for an application's use and popularity, so the feature set in any application is important.

None of the examples described above include features that allow certain details about shared media to be initially hidden, and revealed upon further action. A need exists for media sharing applications that induce or increase user interaction, which may result in increased user enjoyment and drive users to use such applications more often and for more extended periods of time.

### SUMMARY OF THE EMBODIMENTS

The disclosure relates to an application for sharing a visual media from an electronic device. The application includes a visual media selection function that selects a visual media for sharing. A spotlight selection function highlights a spotlight area of the visual media and stores the visual media as a sharing media, including first media in which only the spotlight area is visible, and a second media in which the entire visual media is visible. A first message function stores a first inputted message associated with the first media, and a second message function stores a second inputted message associated with the second media. A share function transmits the sharing media to at least one second electronic device having the application. A view function displays the sharing media on the second electronic device, by first displaying the first media, and then displaying the second media after receiving a user prompt.

### BRIEF DESCRIPTION OF THE DRAWINGS

FIG. 1 shows a home screen of a device including an application as described herein.

FIG. 2 shows a visual media capture screen of the device of FIG. 1.

FIG. 3 shows an import screen of the device of FIG. 1.

FIG. 4 shows a spotlight selection screen of the device of FIG. 1.

FIG. 5 shows the spotlight selection screen of FIG. 4, with the spotlight moved to a different location.

FIG. 6 shows a first message screen of the device of FIG. 1.

FIG. 7 shows a second message screen of the device of FIG. 1.

FIG. 8 shows a preview screen of the device of FIG. 1.

FIG. 9 shows a home screen of a second device, including an application as described herein, displaying a first media from the device of FIG. 1.

FIG. 10 shows the home screen of FIG. 9, displaying a second media from the device of FIG. 1.

FIG. 11 is a flowchart showing process for sharing an item of visual media using an application described herein.

### DETAILED DESCRIPTION OF THE EMBODIMENTS

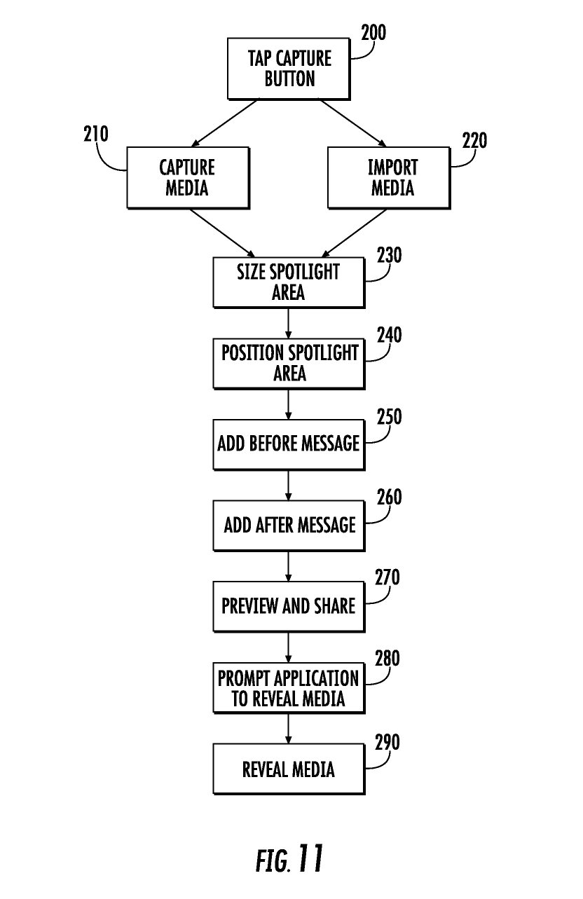

The media sharing application described herein has some of the standard sharing functions combined with a spotlight and reveal feature. The steps for sharing and revealing item of visual media are outlined in FIG. 11, but will be described in detail herein.

As used herein, “media” or “visual media” may include photographs, digital illustrations, other images, as well as videos and other visually-based computer-readable files.

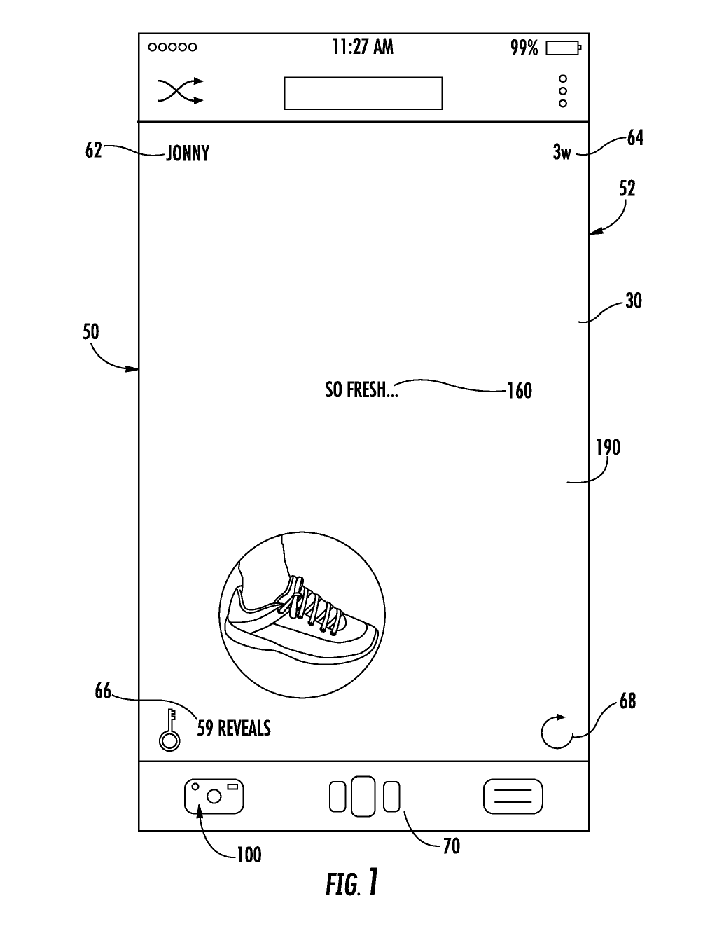

FIGS. 1-10 show a user device 50 containing the media sharing application described herein, at various stages of a method of sharing. The device 52 may be a known type of wireless electronic computing device that includes a processor, display and storage area, such as a smart phone, tablet or personal computer. The display is a touch screen 52 in the embodiment shown, and the device is connected to other devices containing the application via the internet. A user may have an account containing personal details and a record of media previously shared using the application. The user's account may be linked to other accounts, for example by following another individual's account, in which case the user receives notifications of media shared by the account which the user follows. The user's account may also be followed by other accounts (“followers”), in which case the other accounts receive notifications of media shared by the user.

A first stage of the method is shown in FIG. 1. A user may access the application at this stage by opening it on the device 52 and logging into the user's account. The stage shown in FIG. 1 may be referred to as a home screen 30, used to access a home function of the application, which may allow the user to access various features of the application, including viewing media shared by accounts that the user follows, or sharing media.

In the embodiment shown in FIG. 1, the home screen 30 displays a shared media 60, which is illustrated as a photograph but could also be a video or other type of media, from an account followed by the user. Data concerning the shared media 60 may be provided on the home screen 30, such as the username 62 of the individual that shared the media, a timestamp 64 indicating when the media 60 was shared, and a reveal count 66 indicating the number of times the media has been shared and revealed, as described below. The home screen 30 may further include a refresh button 68, allowing the user to refresh the home screen 30, which will result in a display of any new media that have been shared since the user logged in to the application. The home screen 30 may further include a scroll button 70 that the user may activate to scroll through all recently shared media from accounts the user follows, which may be shown in the order of being shared. In another embodiment, multiple photographs from accounts the user follows could be shown on the home screen 30, for example as thumbnails that the user may select to enlarge and view in detail or reveal.

The home screen 30 further includes a camera button 100. The user may actuate the camera button 100 by tapping it, shown as step 200 in the flow chart of FIG. 11, to actuate a visual media selection function of the application.

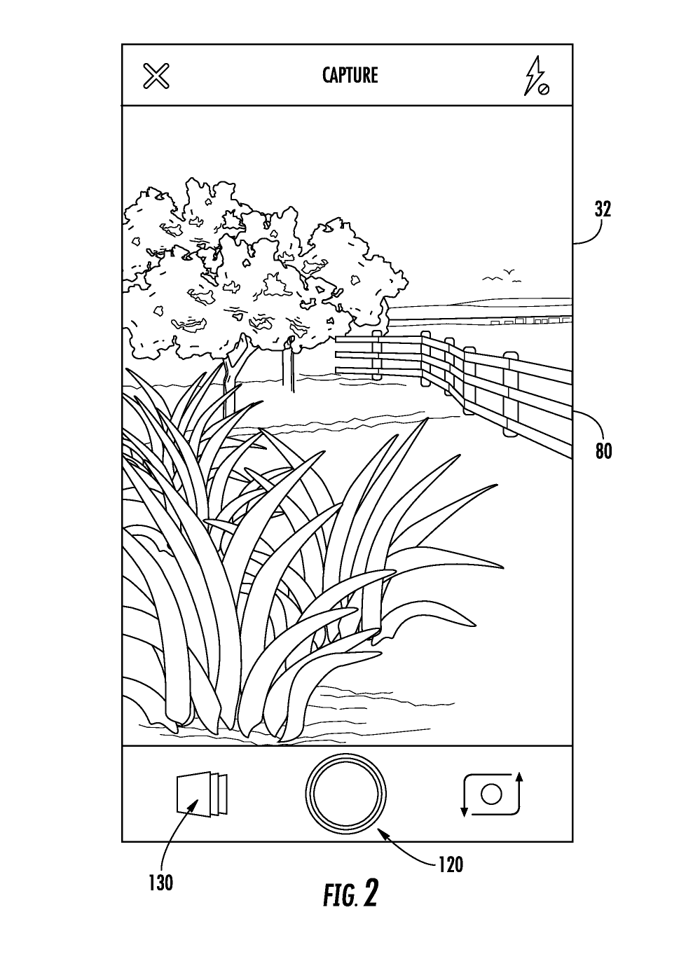

Tapping the camera button 100 takes the user from the home screen 30 to a visual media capture screen 32, shown in FIG. 2. As shown, the media capture screen 32 includes a shutter button 120 as well as an import button 130. The user may actuate the shutter button 120 by tapping it, to capture a photograph or video for sharing, shown as step 210 of FIG. 11. Alternatively, the user may actuate the import button 130 to import an existing photograph or video previously saved to the device 50, shown as step 220 of FIG. 11. The device 50 of the embodiment shown includes a built in camera function, which is automatically activated once the media capture screen 32 is accessed. As shown, the media capture screen 32 includes a visual media display 80 which shows the current view within range of the device's camera. Tapping the shutter button 120 will capture the image as a photograph or video, which will then be available for sharing. In some embodiments, the media capture screen may include multiple shutter buttons 120 designated for capturing photographs, videos or other types of media. In other embodiments, a single shutter button 120 could be employed and actuated differently for capturing different types of media, for example by being pressed quickly to capture a photograph, or held down for an extended time to capture a video.

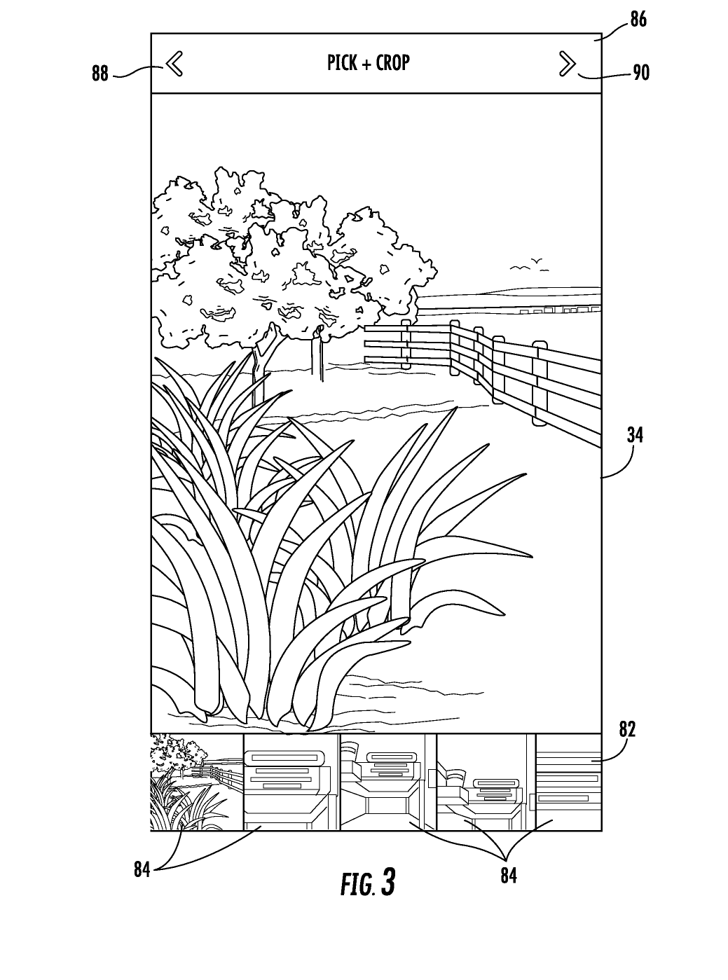

The media capture screen 32 further includes an import button 130 that may be used so select an item of visual media using an import function of the application. Tapping the import button takes the user away from the media capture screen 32, to an import screen 34 shown in FIG. 3. The import screen 34 includes a menu 82 displaying various images or videos stored on the device 50. The menu 82 may include navigation features that allow the user to navigate to various storage areas of the device 50 at which media may be stored. The menu 82 may display stored media, for example as thumbnails 84. In the embodiment shown, the stored media are shown as scrollable thumbnails at the bottom of the media capture screen 32, with a selected item of media 86 being displayed more prominently, for example in larger size above the menu 82 in the embodiment shown. The user may crop the selected media 86, for example by dragging a finger over the selected media to reposition the portion of the selected media within view, as well as by touching the screen with two or more fingers and pinching inward on a selected portion to zoom in, or touching the screen and drawing the fingers apart to enlarge. In some embodiments, the media capture screen 32 may offer further options, such as photo editing features such as filters, light enhancements and color enhancements.

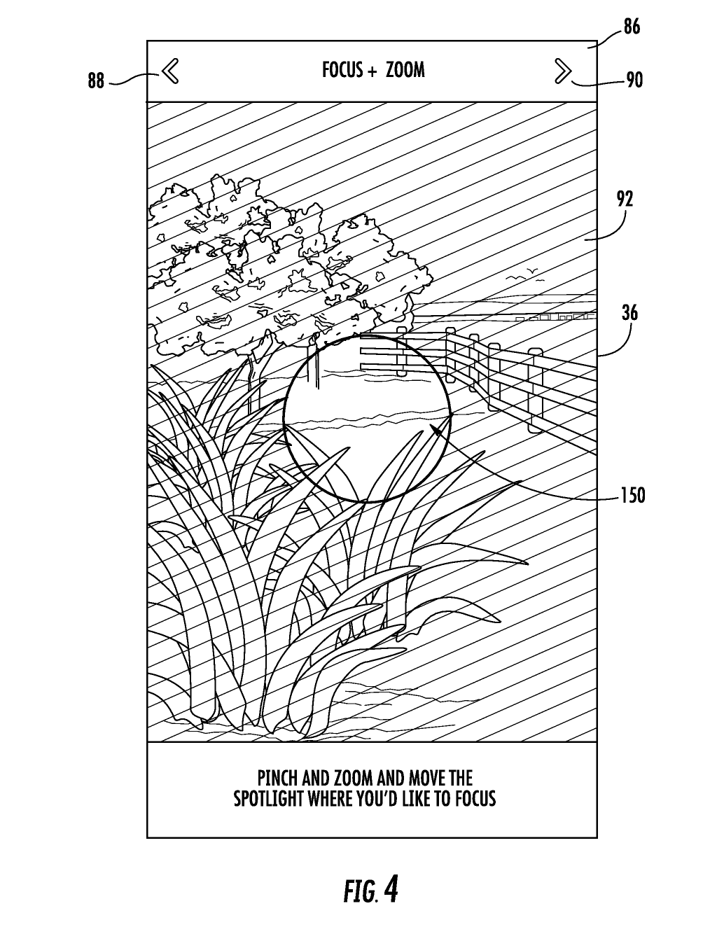

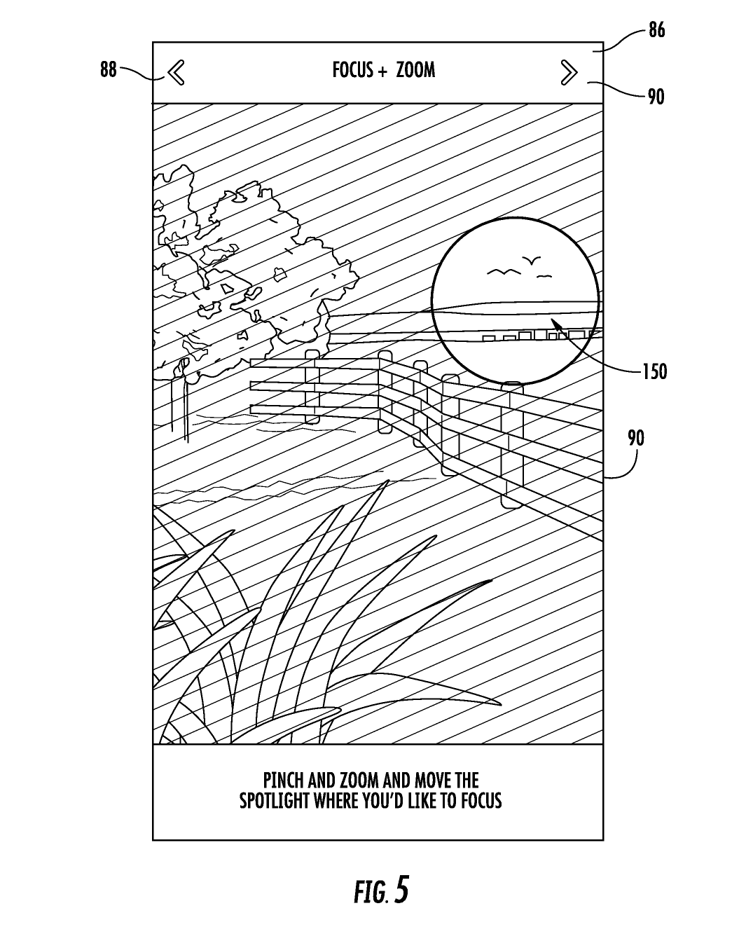

The application further includes a navigation function, which may be accessed via a navigation bar 86, which includes a back button 88 allowing the user to return to the previous screen, and a forward button 90 that allows the user to move on to the next screen. The navigation bar 86 may initially appear at the media capture screen 32, but may be present at all subsequent screens as well, as shown in FIGS. 4-10, allowing the user to easily move forward through the sharing process, or move back to correct errors and make changes. Once the user has finished and cropping a photograph from the media capture screen 32 the forward button 90 may be tapped to proceed to the spotlight selection screen 36, shown in FIGS. 4 and 5, used to access a spotlight selection function of the application.

As shown in FIG. 4, the spotlight selection screen 36 includes a visual media display 92 showing the media taken via the media capture screen 32, or selected at the import screen 34. The display 92 includes area of a spotlight area 150 that is highlighted on the display. In the embodiment shown, the spotlight area 150 is circular, but it may also take on other shapes as well. The user may pinch two or more fingers on the touch screen to zoom in on the media, for sizing the spotlight area 150, shown in FIG. 11 as step 230. The user may further position the spotlight area 150 about the media by dragging with a finger, shown in FIG. 11 as step 240. As shown in FIG. 5, the spotlight area 150 has been moved with respect to that where it was originally positioned in FIG. 4. The media is stored with the spotlight area 150 in the selected position as a first media, and without the spotlight area 150 as a second media, such that upon sharing the first media is initially revealed, followed by the second media, as described in detail below. In some embodiments, the spotlight selection screen may further include a button that allows the user to switch directly between the first media and the second media in order to quickly compare the two.

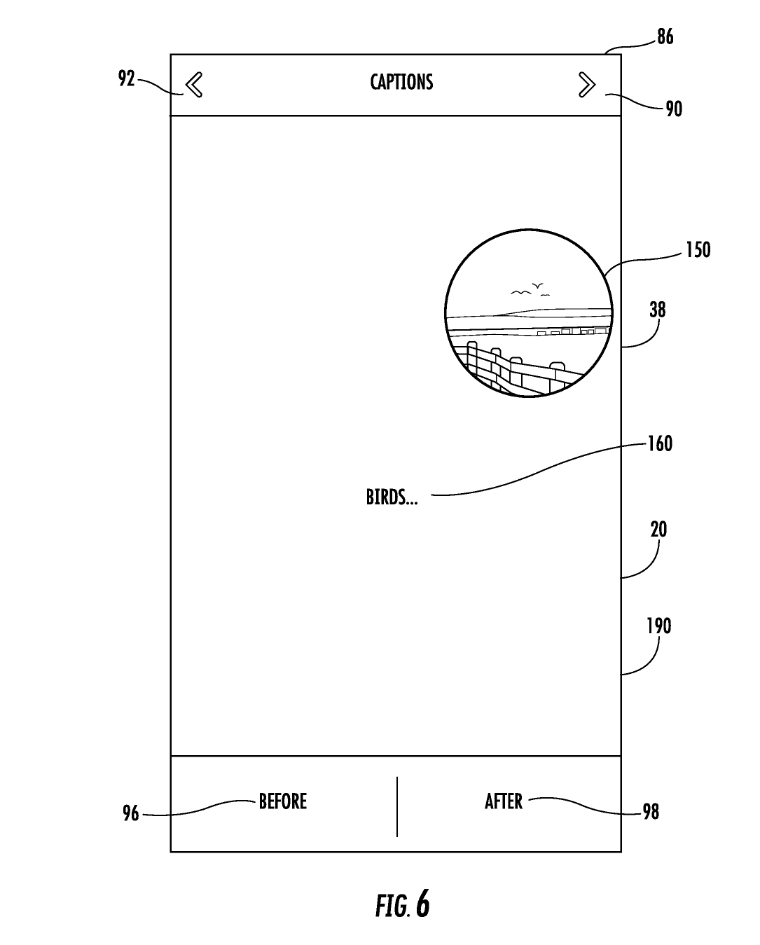

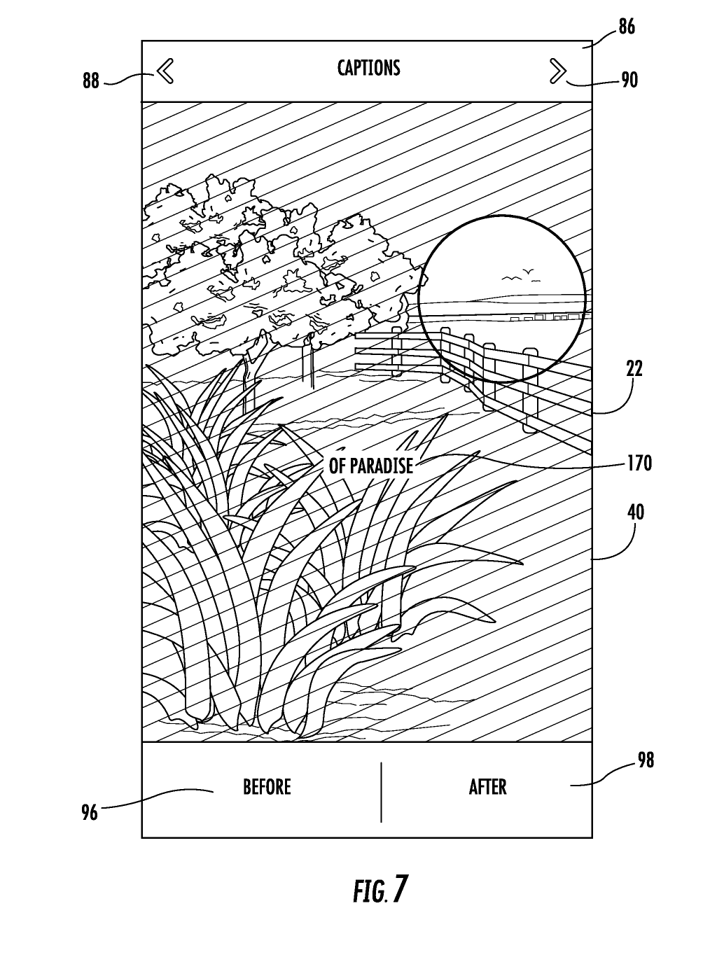

The application further includes a first message function. Once the user is satisfied with the position of the spotlight area 150, the forward button 90 may be tapped to proceed to the first message screen 38, shown in FIG. 6. The application includes both first and second message functions, accessed by first 38 and second 40 message screens, the first message screen shown in FIG. 6 and being associated with a first or before message 160, and the second message screen 40 shown in FIG. 7 and being associated with a second or after message 170.

As shown in FIG. 6, the first message screen 38 includes “before” 90 and “after” designations 98 on the screen, at the bottom of the screen 52 in the embodiment shown, with the before designation 96 highlighted to inform the user that the application is at the first message screen 38. Likewise, as shown in FIG. 7, the second message screen 40 includes the before and after designations, with the after designation 98 highlighted to inform the user that the application is at the second message screen 40.

The first message screen 38 shows the media with only the spotlight area 150 visible and allows the user to input a first or “before” message 160, associated with first the media, shown as step 250 in FIG. 11. The before message 160 may be inputted using a keypad associated with the device, or the application may include a keypad function, for example causing a touch keypad to appear on the screen 52 by actuating a button. The before message 160 may be moved about the screen 52 to a location selected by the user, for example by dragging the before message about the screen 52 with a finger. Once the spotlight area 150 has been selected and the before message 160 has been inputted and positioned, the user may navigate from the first message screen to the second message screen by tapping the forward button 90. At this point, the application saves a first media 20 with the first message 160 and the media with only the spotlight area 150 in view, with the remaining portions of the media hidden beneath an opaque barrier 190.

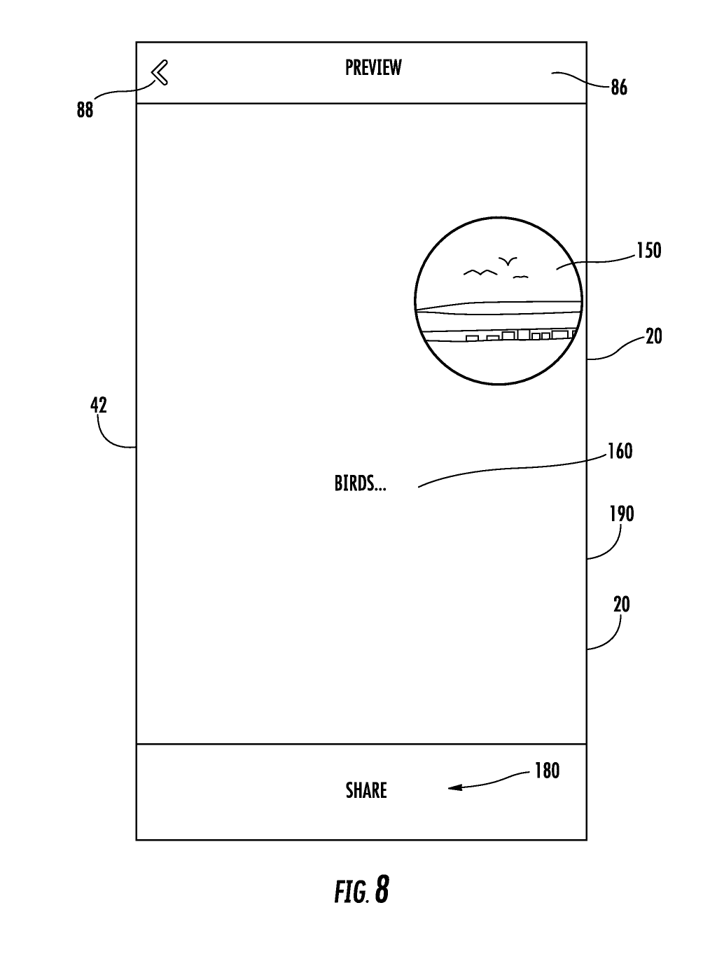

The second message screen 40 shows the entire media with the spotlight area 150 highlighted and allows the user to input a second or “after” message 170, associated with the second media, shown in FIG. 11 as step 260. The after message 170 may also be inputted using a keypad associated with the device, or using a keypad function of the application, and may also be repositioned by dragging, as described above with respect to the before message 160. Once the after message 170 has been inputted and positioned, the user may navigate from the second capture screen 40 to the preview and share screen 42, shown in FIG. 8, to access preview and share functions of the device. At this point, the application saves the second media 22 with the second message 170 at the selected position over the media, with the full media in view. The first and second are stored together as a sharing media.

The application further includes a preview function, accessed via a preview screen. The preview screen 42 may show the first media 20 with the before message 160 for the user to review before sharing, as shown in FIG. 8. In some embodiments, the preview screen 42 may also or alternatively show the second media 22 with the after message 170 for the user to review before sharing. The preview screen 42 further includes a share button 180 which the user may tap to share the media with followers. Previewing and sharing the media are shown in FIG. 11 as step 270.

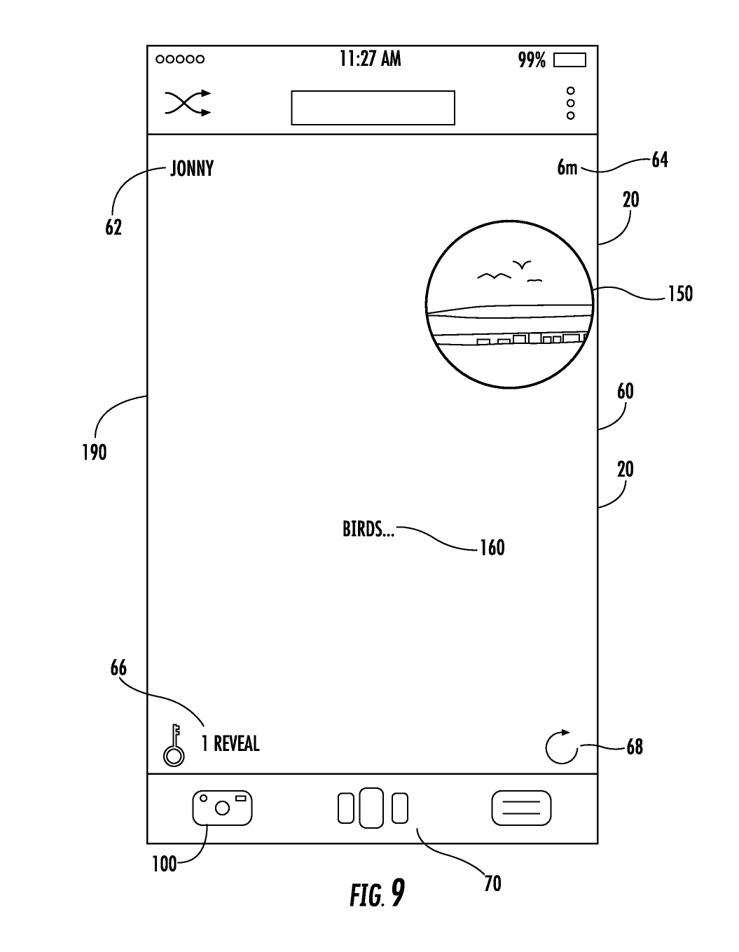

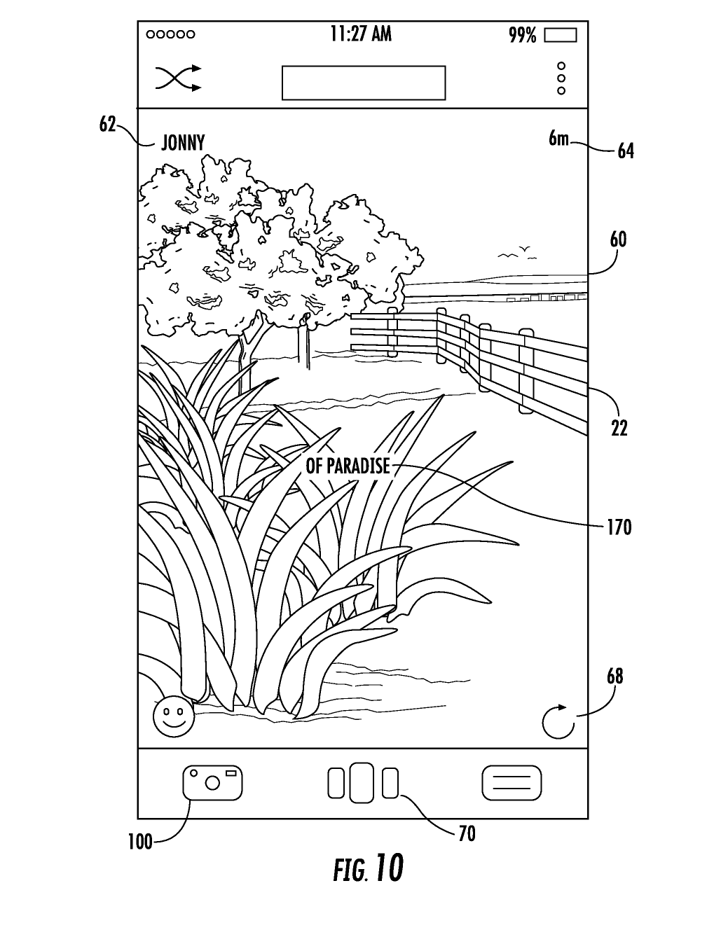

Once the media has been shared, the followers will then be notified of the user's share, and may, upon logging into the application, be shown the first media 20. FIG. 9 shows the first media 20 with the before message 160, as presented on a follower's home screen 30. As shown, this home screen 30 includes the same features as the user's home screen 30, shown in FIG. 1. The follower may prompt the application to reveal the second media, for example by holding down on the touch screen 52 over the spotlight area 150, shown in FIG. 11 as step 280. Upon such a touch or an extended hold touch, the application will reveal the second media. When this occurs, the spotlight area 150 may expand and open up to display the second media 22 with the after message 170 as shown in FIG. 10, including the full media with the spotlight area highlighted and the after message 170 displayed. This is shown in FIG. 11 as step 290. In some embodiments, the second media may be displayed with the spotlight area enlarged, and a zooming out animation may take place as the spotlight area 150 expands, creating a dramatic expansion effect.

Users may share and reveal media as described above as a means of communicating and interacting with each other. In some embodiments, users may challenge each other, for example to guess the meaning of the first message, using the spotlight area as a clue. In some embodiments, users may attempt to come up with clever or insightful first and second messages. For example, in the example shown in FIGS. 2-10, the first message recites “birds,” which may be associated with the spotlight area focusing on the sky shown in the image. When the user navigates to the second shared media it is revealed that the second message reads “of paradise,” and the photograph also contains birds of paradise, which the first message could also have been indicative of. A recipient of this shared media may, upon viewing the first shared media, attempt to guess at what the second message will read or what the entire image will display. In some embodiments, users may challenge each other, for example, to guess at what the second message or image will reveal, or to come up with alternative first or second messages, as well as select different spotlight areas for the same image. Users may also attempt to gain followers by sharing particularly interesting shared media, and in some embodiments users may challenge themselves or others to gain a high number of followers.

While the invention has been described with reference to the embodiments above, a person of ordinary skill in the art would understand that various changes or modifications may be made thereto without departing from the scope of the claims.

1. An application for sharing a visual media from an electronic device, comprising:
a visual media selection function that selects a visual media for sharing;
a spotlight selection function that displays the visual media on a display of the electronic device, highlights a spotlight area of the visual media and stores the visual media as a sharing media including first media wherein only the spotlight area is visible, and a second media wherein the entire visual media is visible and the spotlight area is highlighted;
a first message function that stores a first inputted message associated with the first media;
a second message function that stores a second inputted message associated with the second media;
a share function that transmits the sharing media to at least one second electronic device comprising the application;
a view function that displays the sharing media on the second electronic device, wherein the view function first displays the first media, and then displays the second media after receiving a user prompt.

2. The application of claim 1, wherein the media selection function comprises at least one of a camera function that uses a camera to capture the visual media, or an import function that imports the visual media from a storage area of the device.

3. The application of claim 1, further comprising a visual media editing function that edits the visual media.

4. The application of claim 3, wherein the media editing function comprises a crop function.

5. The application of claim 1, wherein the device comprises a touch screen, and the spotlight selection function displays the visual media and selects the spotlight area by sensing a user's touch over an area of the visual media.

6. The application of claim 1, further comprising a preview function that displays the sharing media on the electronic device before transmitting the sharing media.

7. The application of claim 1, further comprising a home function that displays on the device visual media shared from other electronic devices.

8. The application of claim 1, further comprising a navigation function enabling navigation between the media selection function, the spotlight selection function, the first message function, the second message function, the share function and the view function.

9. The application of claim 1, wherein the electronic device comprises a display, and each of the functions accessed via an individual screen that loads on the display.

10. A method of sharing a visual media from an electronic device, comprising:
providing the electronic device, the electronic device including a visual media sharing application;
loading the visual media sharing application on the electronic device;
navigating to a visual media selection screen of the visual media sharing application, and selecting a visual media;
navigating to a spotlight selection screen of the visual media sharing application and highlighting a spotlight area of the visual media, wherein the application stores the visual media as a sharing media including first media wherein only the spotlight area is visible, and a second media wherein the entire visual media is visible and the spotlight area is highlighted;
navigating to a first message screen of the visual media sharing application and inputting a first message associated with the first media;
navigating to a second message screen of the visual media sharing application and inputting a second inputted message associated with the second media; and
navigating to a share screen of the visual media sharing application and transmitting the sharing media to at least one second electronic device comprising the application.

11. The method of claim 10, further comprising displaying the sharing media by the at least one second electronic device.

12. The method of claim 11, wherein displaying the sharing media by the at least one second electronic device comprises first displaying the first media, then displaying the second media.

13. The method of claim 12, further comprising prompting the at least one second electronic device to display the second media after displaying the first media.

14. The method of claim 13, wherein the device comprises a touch screen, and prompting comprises touching the spotlight area of the screen when displaying the first media.

15. The method of claim 10, further comprising previewing the sharing media prior to transmitting the sharing media to at least one second electronic device.

16. The method of claim 10, wherein selecting a visual media comprises capturing the visual media using a camera of the electronic device, or importing the visual media from a storage area of the device.

17. The method of claim 10, further comprising editing the visual media before navigating to the spotlight selection screen.

18. An electronic device having a visual media sharing application, the electronic device comprising:
a camera;
a storage area;
a display capable of displaying the visual media; and
the application, wherein the application comprises:
a visual media selection function that selects a visual media for sharing;
a spotlight selection function that highlights a spotlight area of the visual media and stores the visual media as a sharing media including first media wherein only the spotlight area is visible, and a second media wherein the entire visual media is visible and the spotlight area is highlighted;
a first message function that stores a first inputted message associated with the first media;
a second message function that stores a second inputted message associated with the second media; and
a share function that transmits the sharing media to at least one second electronic device.

19. The electronic device of claim 18, wherein the media selection function selects a visual media by capturing the visual media using the camera, or importing the visual media from the storage area.

20. The electronic device of claim 18, wherein the display is a touch screen, and commands are inputted into the application using the touch screen.
